(19) United States
(12) Patent Application Publication
(10) Pub. No.: US 2002/0092695 A1
(43) Pub. Date: Jul. 18, 2002

(54) Brake for transaxle and method of assembly

(76) Inventors: Gordon C. Dowen, Salem, IN (US); Kevin L. Johnson, Salem, IN (US)

Correspondence Address: BAKER & DANIELS, 111 E. WAYNE STREET, SUITE 800, FORT WAYNE, IN, 46802

(21) Appl. No.: 10/092,975

(22) Filed: Mar. 7, 2002

Related U.S. Application Data
(63) Continuation-in-part of application No. 09/409,946, filed on Sep. 30, 1999.
(60) Provisional application No. 60/102,898, filed on Oct. 2, 1998.

(51) Int. Cl. B60K 17/00

(52) U.S. Cl. 180/370

(57) ABSTRACT

A braking system for a small utility vehicle, such as a riding lawn mower or lawn tractor, comprising dual braking mechanisms each mounted on the transaxle of the vehicle proximal to the location at which the axles extend from the transaxle, which stop the vehicle by engaging a pair of brake discs each keyed to a respective one of the axles, where each of the braking mechanisms are actuated by the rotation of an attached brake arm having a cam surface that presses at least one friction puck against each respective brake disc.

### CROSS REFERENCE TO RELATED APPLICATIONS

This application claims the benefit under Title 35, U.S.C. § 119(e) of U.S. patent application Ser. No. 09/409,946, entitled AXLE BRAKE FOR TRANSAXLE, filed on Sep. 30, 1999 and of U.S. Provisional Patent Application Serial No. 60/102,898, entitled AXLE BRAKE FOR TRANSAXLE, filed on Oct. 2, 1998.

### BACKGROUND OF THE INVENTION

The field of the present invention is that of braking systems for use with small utility vehicles such as riding lawn mowers, lawn tractors and the like. In particular, the present invention relates to locating the braking mechanisms on the exterior of the transaxle casing.

Typically, small utility vehicles such as riding lawn mowers and lawn tractors contain an internal combustion engine which supplies drive power in the form of rotary mechanical motion to the input of a transaxle. The transaxle then transfers this mechanical motion through a gear box and then to a differential, which splits the rotary mechanical motion between two axles at the output of the transaxle. The axles each terminate with connections to wheels that engage the ground to drive the vehicle. Braking systems are needed for use with the transaxles of such vehicles to allow an operator to slow or stop the forward motion of the vehicle.

Prior known braking systems have employed braking mechanisms that have been mounted within the transaxle casings. A problem with this location for the braking mechanisms is that the braking mechanisms must be initially assembled contemporaneously within the transaxle casings, and therefore any design changes in such braking mechanisms necessarily require additional complementary design changes in the transaxle casings. A further problem with this location for the braking mechanisms is that the transaxle casings must be separated and the transaxle partially disassembled in order to access the braking mechanisms for servicing. In addition, locating the braking mechanisms within the transaxle casings increases the likelihood that they will be contaminated by oil, grease or other lubricants used to lubricate the gears and shafts within the transaxle.

Prior known braking systems have also applied braking force by engaging a brake disc attached to an intermediate shaft, such as a brake shaft, located between the input of the transaxle and the axles. A problem with this braking arrangement is that braking force is applied to the axles only indirectly because there is one or more gearing arrangements between where the brake force is applied and the wheels of vehicle. In some situations, the gearing may allow the vehicle to continue to move forward despite the application of the braking force.

Other prior known braking systems have comprised a single braking mechanism that engages only one of the axles by means of a brake disc attached to that axle. Such a braking system is not always effective in entirely stopping the forward motion of the vehicle because in some situations although one of the axles has been stopped due to the application of a braking force, the other axle may continue to rotate through the operation of the differential.

A braking system for a small utility vehicle, such as a riding lawn mower or lawn tractor, that effectively stops the entire forward motion of the vehicle is desirable.

A braking system that contains braking mechanisms mounted such that the braking mechanisms are readily accessible for servicing, cannot be contaminated by oil, grease, or other lubricants from within the transaxle casings, and can be shipped with the transaxle as a single unit to the final vehicle assembly location for “drop” installation into the vehicle is also desirable.

A braking system that employs existing braking mechanism designs without the need for changing existing designs of the transaxle is also desirable.

### SUMMARY OF THE INVENTION

The present invention provides a braking system that employs dual braking mechanisms mounted externally on a transaxle casing at the location where the axles extend therefrom. These braking mechanisms may apply braking force directly and simultaneously to both of the axles by engaging brake discs keyed to wheels mounted on each of the axles, thereby slowing or stopping the entire forward motion of the vehicle. Alternatively, the braking mechanisms may apply braking force independently such as in an application where the vehicle is to be steering assisted or in a limited-slip type of application. Each braking mechanism is nearly identical to existing known designs, such as that disclosed in U.S. Pat. No. 5,195,386, assigned to the assignee of the present application, and is hereby incorporated by reference. The use of such known braking mechanism designs eliminates the need for additional costs associated with developing new designs or retooling existing manufacturing facilities.

Further, the location of the braking mechanisms externally on the transaxle casing allows the braking mechanisms and transaxle to be first assembled separately, then later attached and shipped together as a unit to the final vehicle assembly location for “drop” installation into the vehicle. Also, locating the braking mechanisms externally on the transaxle casing exposes them for easier servicing and eliminates the possibility of the braking mechanisms being contaminated by oil, grease, or other lubricants found within the transaxle casings.

In an illustrated embodiment of the present invention, the braking system contains linkage connecting the braking mechanisms to a manually operable pedal, lever or the like. This linkage consists of a longitudinal rod attached to the pedal, and also rotatably connected to one of two transition arms incorporated in a cross shaft that is rotatably connected to the vehicle frame at both ends. Two actuator rods rotatably connect each transition arm to brake arms, which are connected to and actuate the braking mechanisms. In this embodiment, the braking mechanisms are actuated by a vehicle operator applying manual force to a pedal, lever, or the like which pulls the longitudinal rod in a horizontal direction, rotating the transition arms and the cross shaft. The rotation of the cross shaft pulls the actuator rods in a vertical direction, rotating the brake arms which actuate the braking mechanisms.

A further aspect of the invention provides a method of assembling a vehicle having a transaxle. This method includes providing a vehicle frame, attaching a transaxle having a casing and a pair of axles to the frame, mounting a pair of braking mechanisms to the exterior of the transaxle casing, and mounting a pair of braking discs to the axles. The braking discs are relatively rotational with respect to said axles and brakingly engageable by the braking mechanisms, i.e., the engagement of the braking discs by the braking mechanisms enables the braking mechanisms to apply a braking force to the braking discs. The method also involves mounting a pair of wheels to the axles after mounting the braking discs to the axles wherein the mounting of the wheels includes rotationally fixing the wheels relative to a respective one of the axles and rotationally fixing the wheels to a respective one of the braking discs whereby the mounting of the wheels rotationally fixes the braking discs to the axles.

This method may also advantageously include mounting the braking discs on the axles at locations where the axles have a solid cylindrical shape. The braking discs may also be provided with lugs and the wheels provided with corresponding recesses whereby the mounting of the wheels includes engaging the braking disc lugs with the corresponding recesses on the wheels to rotationally fix the wheels and braking discs.

### BRIEF DESCRIPTION OF THE DRAWINGS

The above mentioned and other features and objects of this invention, and the manner of attaining them, will become more apparent and the invention itself will be better understood by reference to the following description of the invention taken in conjunction with the accompanying drawings, wherein:

FIG. 1 is a rear elevational view of a portion of a small utility vehicle, such as a lawn mower or lawn tractor, illustrating the vehicle frame above the transaxle, with axles extending therefrom and terminating in connections to wheels, and the braking system with linkage;

FIG. 2 is a right side end view, viewed down the right axle with the wheel and tire shown in phantom;

FIG. 3 is a right side view, viewed down the right axle from the inside of the right braking mechanism with the brake disc shown in phantom;

FIG. 4 is a cross section of the left side braking mechanism of FIG. 1;

FIG. 5 is a perspective view of a transaxle, with axles extending therefrom, a pair of braking mechanisms, a pair of braking discs and a wheel;

FIG. 6 is a perspective view of a portion of the transaxle casing with an axle extending therefrom, a braking mechanism and a braking disc; and

FIG. 7 is a perspective view of a braking disc engaged with a wheel.

Corresponding reference characters indicate corresponding parts throughout the several views. Although the drawings represent the present invention, the drawings are not necessarily to scale and certain features may be exaggerated in order to better illustrate and explain the present invention. The exemplification set out herein illustrates an embodiment of the invention, in one form, and is not intended to be exhaustive or limit the invention to the precise form disclosed in the following detailed description or be construed as limiting the scope of the invention in any manner.

### DETAILED DESCRIPTION

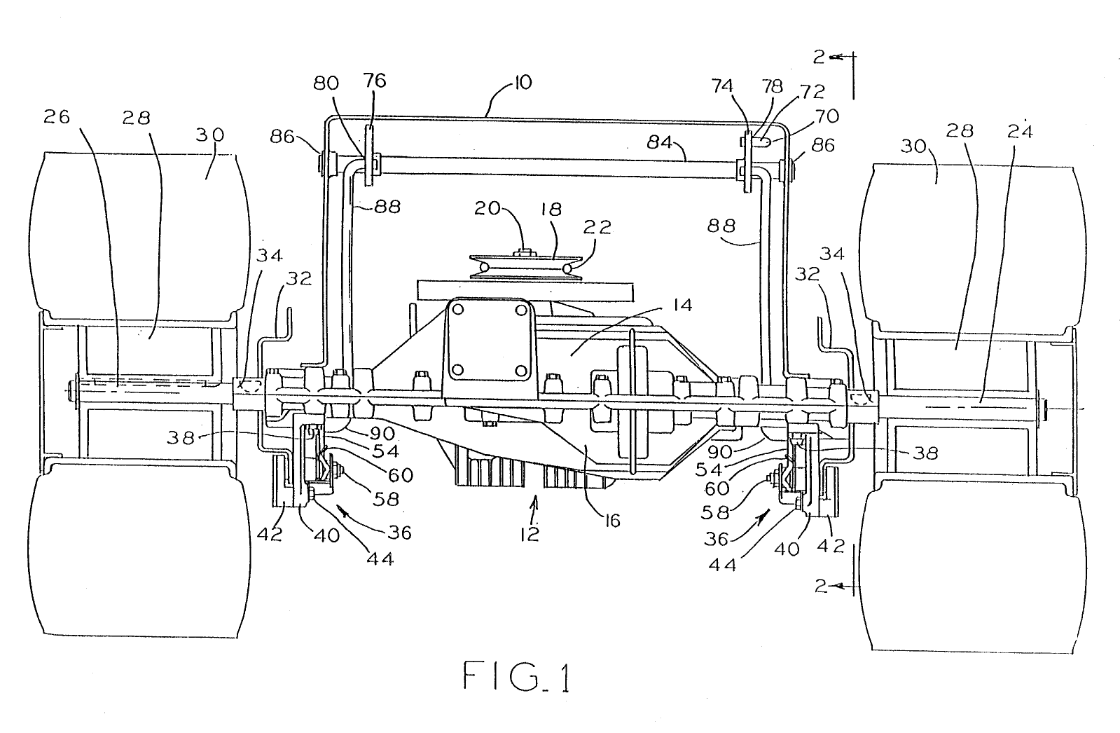

Referring to FIG. 1, a rear elevational view of a portion of a small utility vehicle is shown. Attached to and disposed substantially below the vehicle frame 10 is transaxle 12, including a casing comprising upper transaxle casing half 14 and lower transaxle casing half 16. As may be seen in FIGS. 1, 2, 3, and 4, upper and lower transaxle casing halves 14 and 16, respectively, are split along a plane coincident with right axle 24 and left axle 26. Transaxle 12 may be either a hydrostatic transaxle, such as that disclosed in U.S. Pat. No. 5,392,603, or a gear type transaxle, such as that disclosed in U.S. Pat. No. 5,211,067, both assigned to the assignee of the present application, and hereby incorporated by reference. Pulley 18 is rotatably mounted by means of bolt 20 on the top of upper transaxle casing half 14 and keyed to an input shaft (not shown). Belt 22 is wrapped around pulley 18 and also wrapped around a second pulley (not shown) operably connected to the engine (not shown). Belt 22 transfers rotary mechanical motion from the engine to pulley 18 and the input shaft of transaxle 12. Rotary mechanical motion can also be transferred from the engine to the input of the transaxle 12 by a rotating shaft. This rotary mechanical motion is diverted through a gear train or hydrostatic transmission (not shown) within transaxle 12 and then to a differential (not shown) within transaxle 12 which splits the motion between right axle 24 and left axle 26.

Right axle 24 and left axle 26 are rotatably disposed internally within transaxle 12, and further extend therefrom in opposite directions externally from transaxle 12. Right axle 24 and left axle 26 terminate with connections to wheels 28 on which tires 30 are mounted. Wheels 28 are connected to right axle 24 and left axle 26 in the customary manner. Proximal to the location at which right axle 24 and left axle 26 extend from upper and lower transaxle casing halves 14 and 16, respectively, brake discs 32 with integral collar portions 34 are keyed to and rotate with right axle 24 and left axle 26. Collar portions 34 are located proximal to upper and lower transaxle casing halves 14 and 16, respectively, and wheels 28.

Braking mechanisms 36, each as described in U.S. Pat. No. 5,195,386, are mounted to lower transmission casing half 16 by means of attachment bolts 38 proximal to the location at which right axle 24 and left axle 26 extend from upper and lower transaxle casing halves 14 and 16, respectively. Braking mechanisms 36, apply braking force to right axle 24 and left axle 26 by engaging brake discs 32, thereby stopping the rotation of both right axle 24 and left axle 26 to which brake discs 32 are keyed. Stopping both the rotation of right axle 24 and left axle 26 stops the entire forward motion of the vehicle. Alternatively, braking mechanisms 36 may operate to apply braking force to right axle 24 and left axle 26 independently, as when the vehicle is to be steering assisted or in a limited-slip type of application. In the embodiment illustrated by FIGS. 1, 2, and 3, braking mechanisms 36 are mounted to and disposed below lower transaxle casing half 16. However, braking mechanisms 36 may also be mounted to and disposed above upper transmission casing half 14.

As shown in FIGS. 1, 2, 3, and 4, braking mechanisms 36 comprise an inner housing 40 and an outer housing 42. Inner housings 40 are mounted to lower transaxle casing half 16 by means of attachment bolts 38 (FIG. 1) proximal to the location at which right axle 24 and left axle 26 extend from upper and lower transaxle casing halves 14 and 16, respectively.

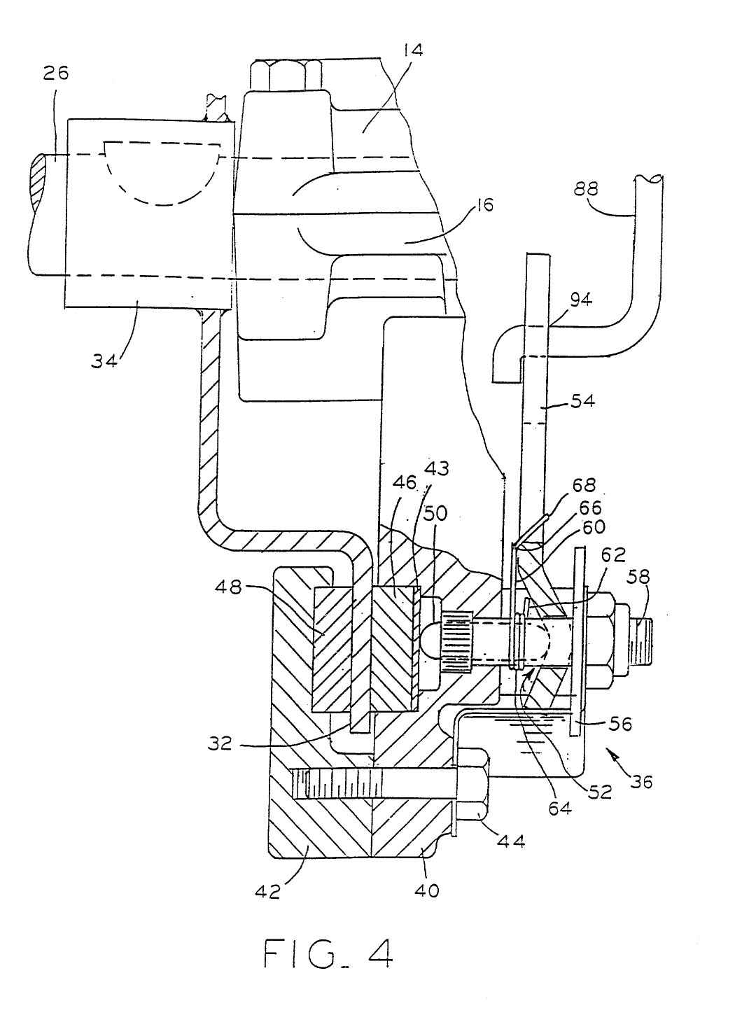

As shown in FIG. 4, outer housing 42 is connected to inner housing 40 by means of connecting bolts 44. Inner and outer friction pucks 46 and 48, respectively, are contained within inner housing 40 and outer housing 42 on both sides of brake disc 32. Metal backing plate 43 is attached to one side of inner friction puck 46. A slight end play permits brake disc 32 to move against outer friction puck 48. Brake pins 50 are disposed within inner housing 40 and have ends abutting both V-shaped cam surface 52 and inner friction puck 46. V-shaped cam surface 52 is incorporated within brake arm 54, which abuts brake pins 50 and washer 56 on mounting bolt 58. Brake arm 54 is mounted and rotatable on mounting bolt 58 extending into inner housing 40.

In a disengaged position, brake arm 54 is disposed as illustrated in FIGS. 1, 2, 3, and 4, and brake pins 50 are disposed within the valley of V-shaped cam surface 52. Brake disc 32 may thus freely rotate in between inner friction puck 46 and outer friction puck 48 without contacting either inner friction puck 46 or outer friction puck 48. Thus, right and left axles 24 and 26, respectively, to which brake discs 32 are keyed, may also freely rotate.

Referring to FIGS. 1, 2, 3, and 4, it will be seen that when engaged, brake arm 54 is rotated around mounting bolt 58, and V-shaped cam surface 52 engages brake pins 50 and thereby presses metal backing plate 43 and inner friction puck 46 outwardly toward brake disc 32. The slight end play of brake disc 32 permits brake disc 32 to move against outer friction puck 48 such that brake disc 32 is in effect squeezed between inner and outer friction pucks 46 and 48, respectively. Rotation of brake discs 32 is thus frictionally slowed or stopped along with the rotation of right axle 24 and left axle 26, to which brake discs 32 are keyed.

As shown in FIGS. 1, 3 and 4, brake mechanisms 54 may be fitted with torsion springs 60, nearly identical to those described in U.S. Pat. No. 5,195,386. Torsion springs 60, which are operably connected to brake arm 54 to bias brake arm 54 rotationally and to align brake arm 54 in its disengaged position. Torsion spring 60 includes base portion 62, coil portion 64, and extending portion 66. Base portion 62 is connected to the bottom of inner housing 40. Coil portion 64 is disposed around mounting bolt 58 between inner housing 40 and V-shaped cam surface 52 of brake arm 54. Extending portion 66 extends adjacent to one side of brake arm 54 and has finger 68 which wraps around the side of brake arm 54. The spring tension of coil portion 64 biases the rotational position of brake arm 54 to its disengaged position by the wrapped around connection of finger 68 of extending portion 66. The abutment of extending portion 66 with the side of brake arm 54 aligns brake arm 54.

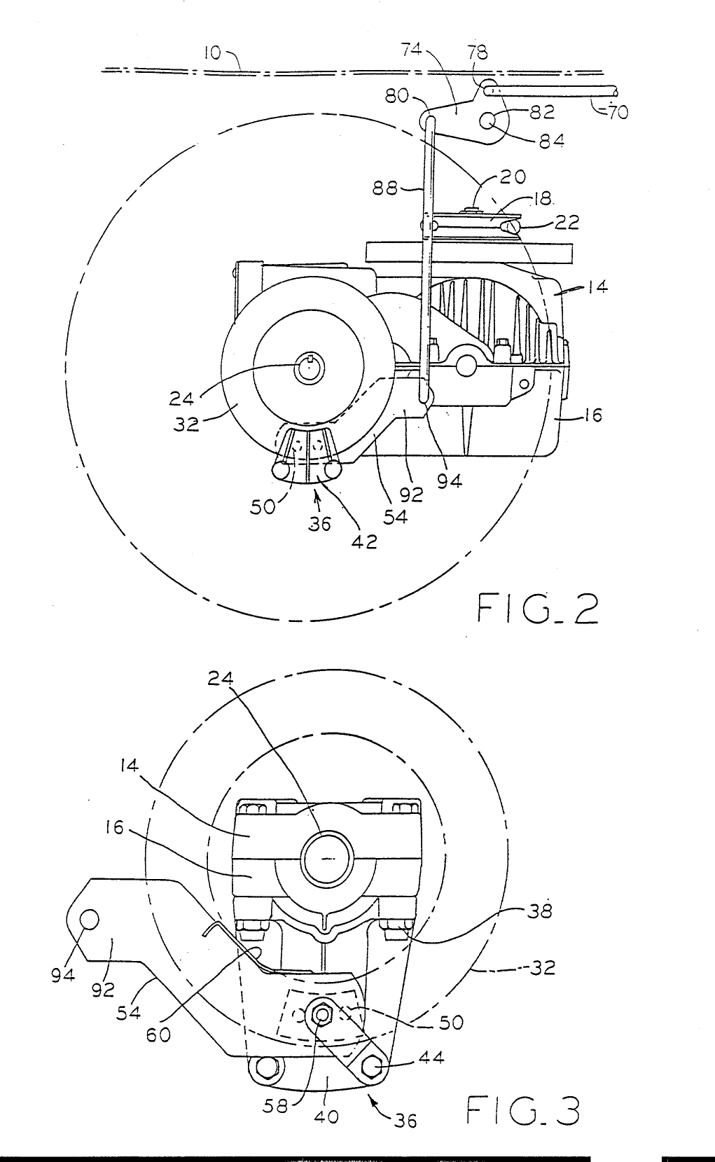

Referring to FIGS. 1 and 2, an embodiment of a braking linkage is illustrated. Longitudinal rod 70 is connected to a manually operable brake pedal, lever, or the like at one end (not shown), and at the opposite bent end 72 rotatably engages right transition arm 74 through aperture 78. Bent end 72 of longitudinal rod 70 may be secured to right transition arm 74, for example, by a cotter pin or the like (not shown). Right transition arm 74 contains two apertures 78 and 80, as well as cross shaft aperture 82. Left transition arm 76 includes aperture 80 and cross shaft aperture 82. Right and left transition arms 74 and 76, respectively, are each fixedly connected to cross shaft 84 through cross shaft apertures 82 and rotate with cross shaft 84. Cross shaft 84 is rotationally connected at each end to vehicle frame 10 through apertures 86.

Brake actuator rods 88 have bent ends 90 which rotationally engage right and left transition arms 74 and 76, respectively, through apertures 80. Brake actuator rods also rotationally engage end portions 92 of brake arms 54 through apertures 94. Brake actuator rods 88 may be secured at their bent ends 90 to right and left transition arms 74 and 76 respectively, and to brake arms 54, for example, by cotter pins or the like (not shown).

second embodiment of braking linkage (not shown) may comprise a pair of Bowden cables attached to a manually operable brake pedal, lever, or the like (not shown), the cables routed around a pulley on cross shaft 84 and connected to the brake arms 54 such that when the cable is drawn forward by application of manual force to the brake pedal, lever, or the like, the brake arms 54 are rotated, and the braking mechanisms 36 thus engaged.

Referring to the embodiment of the braking mechanism and linkage illustrated in FIGS. 1, 2, 3, and 4, it will be seen that when longitudinal rod 70 is drawn horizontally forward by the application of manual force to a brake pedal, lever, or the like (not shown), right transition arm 74 will rotate, along with cross shaft 84 and left transition arm 76. Right and left transition arms 74 and 76 respectively, when thus rotated, will pull brake actuator rods 88 in an upward, vertical direction and rotate brake arms 54. Brake arms 54 rotate around their respective mounting bolts 58, causing the V-shaped cam surfaces 52 on the brake arms 54 to also rotate, engaging brake pins 50 and thereby pressing inner friction pucks 46 towards brake discs 32. Brake discs 32 are then pressed against outer friction pucks 48 and thus effectively squeezed between inner and outer friction pucks 46 and 48, respectively. The rotation of brake discs 32 is thus frictionally slowed or stopped, along with right axle 24 and left axle 26, to which brake discs 32 are keyed.

Although the mechanism just described causes the brakes to be actuated simultaneously, the brakes could be linked in such a manner as to be operated independently. For example, independent Bowden cables could extend to each brake from separate control levers or pedals. Actuating the brakes independently enables the braking mechanism to be applied where the vehicle is to be steering assisted or in a limited-slip type of application. Furthermore, although a specific brake linkage mechanism has been described, it is only one of many possibilities.

If desired, the braking mechanisms 36 can include a self-adjustment mechanism as disclosed in allowed application, Ser. No. 09/165,904, filed Oct. 2, 1998, Self-Adjustable Brake, Gordon C. Dowen, now U.S. Pat. No. 6,123,182, which is hereby incorporated herein by reference.

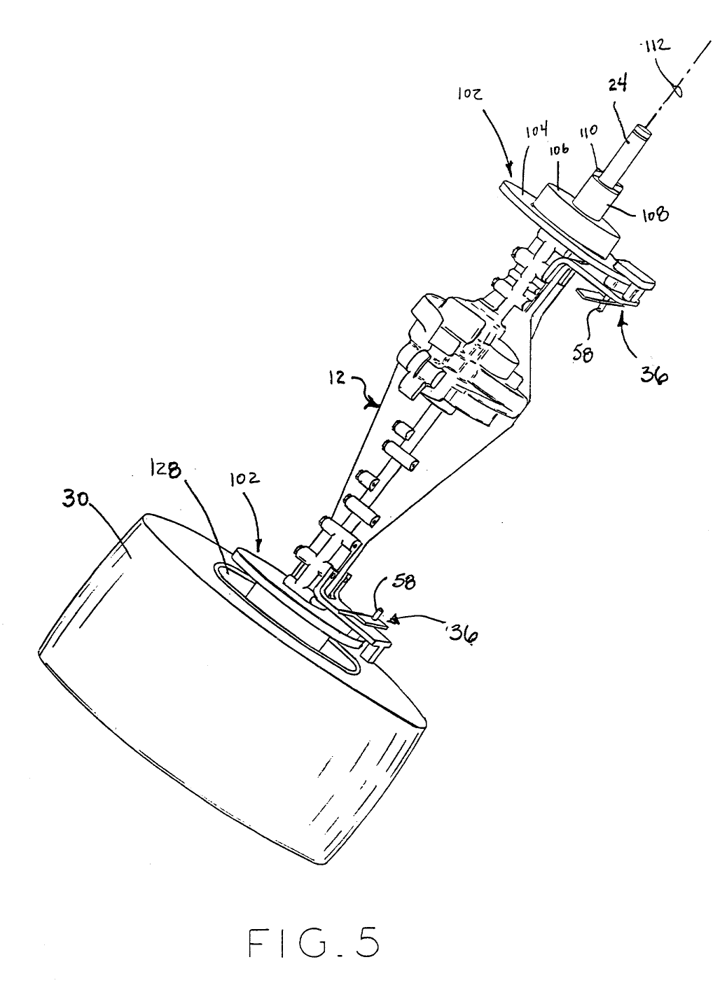

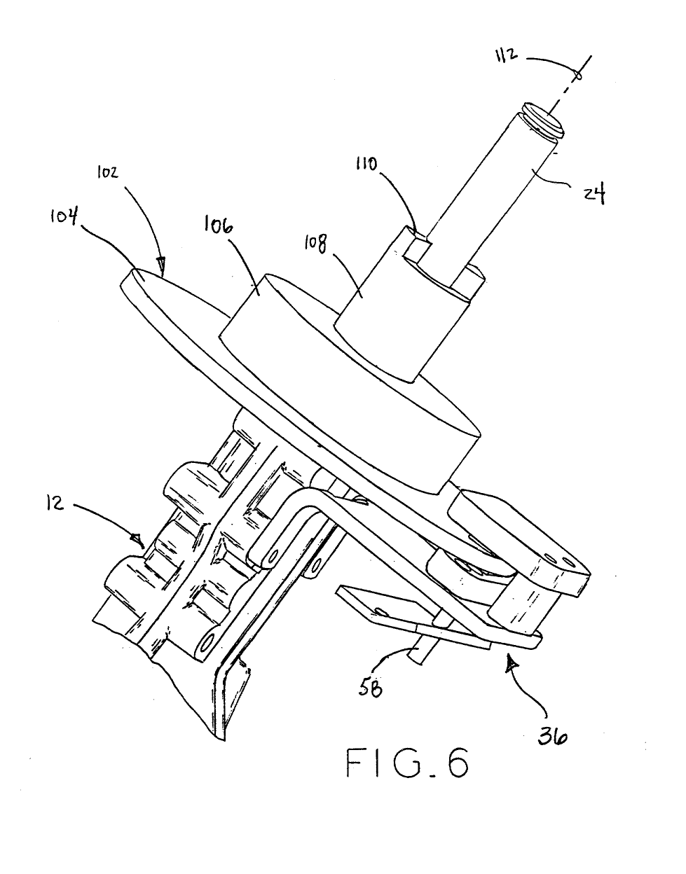

An another embodiment having an alternative braking disc arrangement is shown in FIGS. 5-7. The embodiment of FIGS. 5-7 uses a pair of braking mechanisms 36 which are similar to those described above and which are mounted to the exterior of the casing of the transaxle 12. The nut and washer located on mounting bolt 58 and depicted in FIGS. 1 and 4 are not shown in FIGS. 5, 6 and 7 for purposes of clarity only and would be used with the mounting bolt 58 illustrated in FIGS. 5, 6 and 7 in the same manner illustrated in FIGS. 1 and 4.

Brake discs 102, illustrated in FIGS. 57, have an outer flange 104 which is gripped by the braking mechanisms 36 and a stepped down portion 106 similar to brake discs 32 discussed above. Brake discs 102 also have a collar portion 108 which in the illustrated embodiment takes the form of a cylindrical sleeve which defines an opening through which the axle extends.

Prior to mounting the wheel 128 to the axle, the brake disc 102 is mounted on the axle as can be seen with regard to the right axle 24 in FIG. 5. Unlike brake discs 32, brake discs 102 are not directly keyed to the axle and that portion of the axle on which the brake discs 102 are mounted does not require any keyway recess. The axle at this location may, therefore, retain a solid cylindrical form and avoid the stress concentrations created by the use of a keyway recess in the axle and thereby provide an axle having a greater strength than a similar axle having a keyway recess.

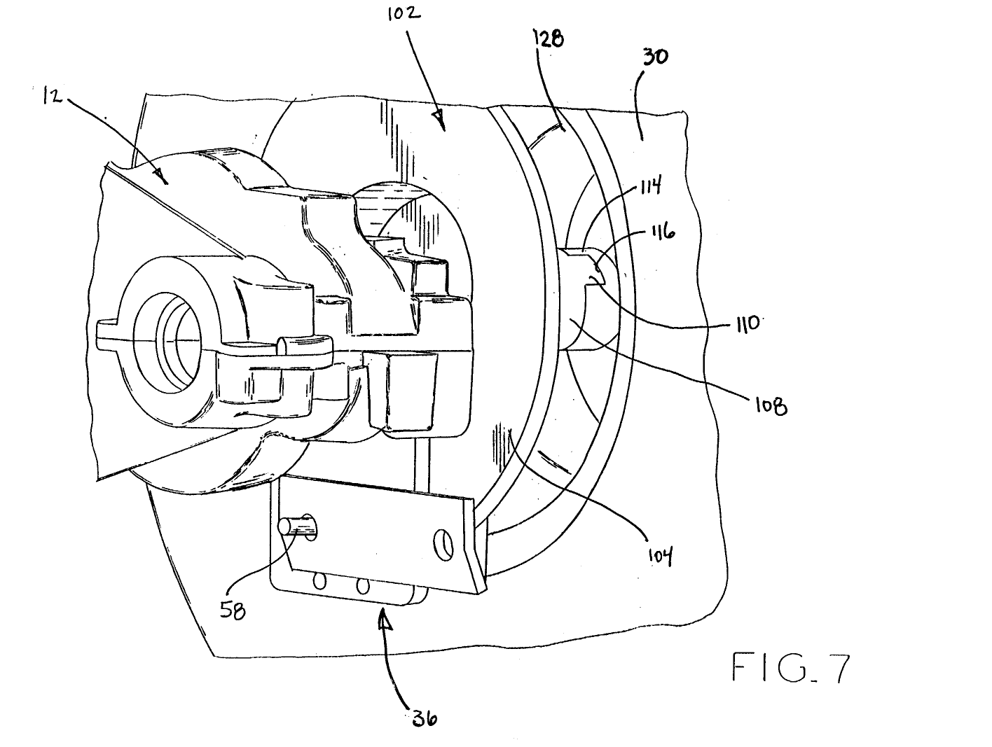

Since the brake discs 102 are not keyed to the axles and have a collar portion 108 which defines a generally cylindrical opening through which the axle extends, the interior surface of the brake disc opening which directly engages the axle permits rotation of the brake disc on the axle. Consequently, when brake discs 102 are mounted on the axles, the brake discs 102 may be rotated relative to the axle prior to the mounting of the wheels 128. The brake discs 102 include projecting lugs 110 which project parallel to the common axis 112 of the axles. Projecting lugs 110 are used to engage the wheels 128. As shown in FIG. 7, wheels 128 have a central sleeve 114 which includes recesses 116 which receive lugs 110. When lugs 110 are seated within recesses 116, the brake discs 102 and wheels 128 are rotationally fixed relative to each other.

Wheels 128 are mounted to the axles in a conventional manner similar to wheels 28 which rotationally fixes each wheel 128 relative to the axle on which the wheel 128 is mounted. For example, the wheels could be mounted using either a splined or key/keyway interconnection. Since the wheels 128 are rotationally fixed relative to both the braking disc 102 and the axle, the braking disc 102 and axle will be rotationally fixed relative to each other.

Although the illustrated embodiment has projecting lugs 110 on the brake disc 102 and corresponding recesses 116 on the wheel to rotationally fix the brake discs and wheels together, the lugs may alternatively be located on the wheels and the recesses on the brake discs. Other attachment methods, such as a bolted attachment, could also be used to secure the wheels and brake discs together to prevent their relative rotation.

While this invention has been described and illustrated in an example embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A small utility vehicle, comprising:
a vehicle frame;
a transaxle having a casing attached to said frame;
a pair of axles extending along a common axis, each of said axles rotatably disposed in and having a portion extending from said transaxle casing;
a pair of wheels, each of said wheels rotationally fixed to a respective one of said axles;
a pair of brake discs, each of said brake discs having a collar portion defining an opening therethrough, each of said brake discs being mounted on a respective one of said axles, said axles extending through said collar portion openings, and said brake discs disposed between a respective one of said wheels and said transaxle casing, each of said brake discs being rotationally fixedly engaged to a respective one of said wheels; and
a pair of braking mechanisms externally mounted on said transaxle casing proximate to a location where a respective one of said axles extends from said transaxle casing, each of said braking mechanisms being brakingly engageable with a respective one of said braking discs.

2. The vehicle of claim 1 wherein said braking discs are positioned on said axles at locations where said axles have a solid cylindrical shape.

3. The vehicle of claim 2 wherein surfaces on said braking discs and said axles in direct engagement permit relative rotation between said braking discs and said axles and said wheels are rotationally fixed relative to both said braking discs and said axles whereby said braking discs are rotationally fixed relative to said axles.

4. The vehicle of claim 3 wherein said braking discs each have at least one lug projecting parallel to said common axis, said lugs rotationally fixing said braking discs to said wheels.

5. The vehicle of claim 1, wherein each of said braking mechanisms applies braking force to each of said axles simultaneously.

6. The vehicle of claim 1, wherein each of said braking mechanisms applies braking force to each of said axles independently.

7. The vehicle of claim 1, wherein each of said braking mechanisms contains a pair of friction pucks disposed respectively adjacent each side of one of said brake discs.

8. The vehicle of claim 7, wherein each of said braking mechanisms comprises a housing in which said friction pucks are disposed, said housings externally mounted on said transaxle casing proximal to the location at which said axles extend therefrom.

9. The vehicle of claim 1, wherein said transaxle is a hydrostatic transaxle.

10. The vehicle of claim 1, wherein said transaxle is a gear-type transaxle.

11. A transaxle for a small utility vehicle comprising:
a transaxle casing;
a pair of axles extending along a common axis, each of said axles rotatably disposed in and having a portion extending from said transaxle casing;
a pair of wheels, each of said wheels rotationally fixed to a respective one of said axles;
a pair of brake discs, each of said brake discs having a centrally disposed collar with an opening therethrough, each of said brake discs being mounted on a respective one of said axles with said axles extending through said openings, said brake discs disposed between a respective one of said wheels and said transaxle housing; and
a pair of braking mechanisms externally mounted on said transaxle casing proximate to a location where a respective one of said axles extends from said transaxle casing, each of said braking mechanisms comprising a brake arm having a cam surface that presses at least one friction puck against a respective brake disc when said brake arm is actuated.

12. The vehicle of claim 11 wherein said braking discs are positioned on said axles at locations where said axles have a solid cylindrical shape.

13. The vehicle of claim 12 wherein surfaces on said braking discs and said axles in direct engagement permit relative rotation between said braking discs and said axles and said wheels are rotationally fixed relative to both said braking discs and said axles whereby said braking discs are rotationally fixed relative to said axles.

14. The vehicle of claim 13 wherein said braking discs each have at least one lug projecting parallel to said common axis, said lugs rotationally fixing said braking discs to said wheels.

15. The vehicle of claim 11, wherein each of said braking mechanisms applies braking force to each of said axles simultaneously.

16. The vehicle of claim 1 1, wherein each of said braking mechanisms applies braking force to each of said axles independently.

17. A method of assembling a vehicle comprising:
providing a vehicle frame;
attaching a transaxle assembly to said frame, said transaxle assembly including a transaxle casing and a pair of axles rotatably disposed in and extending from said transaxle casing;
mounting a pair of braking mechanisms to an exterior of said transaxle casing;
mounting a pair of braking discs to said axles, said braking discs being relatively rotational with respect to said axles, said discs being brakingly engageable by said braking mechanisms;
mounting a pair of wheels to said axles after mounting said braking discs to said axles, said mounting of said wheels including rotationally fixing said wheels relative to a respective one of said axles and rotationally fixing said wheels to a respective one of said braking discs whereby mounting of said wheels rotationally fixes said braking discs to said axles.

18. The method of claim 17 wherein mounting said braking discs comprises positioning said braking discs on said axles at locations where said axles have a solid cylindrical shape.

19. The method of claim 17 wherein said braking discs are provided with lugs and said wheels are provided with corresponding recesses and said mounting of said wheels comprises engaging said lugs with said corresponding recesses to rotationally fix said wheels and said braking discs.
